(19) United States
(12) Patent Application Publication
(10) Pub. No.: US 2020/0232623 A1
(43) Pub. Date: Jul. 23, 2020

(54) FORMED CELLULAR LIGHTING ELEMENTS AND LIGHTING DEVICES INCLUDING THE SAME

(71) Applicant: OSRAM SYLVANIA Inc., Wilmington, MA (US)

(72) Inventors: Bruce Radl, Stow, MA (US); Zhuo Wang, Pleasanton, CA (US); Douglas Harriott, Melrose, MA (US)

(73) Assignee: OSRAM SYLVANIA Inc., Wilmington, MA (US)

(21) Appl. No.: 15/757,910

(22) PCT Filed: Sep. 29, 2016
(86) PCT No.: PCT/US2016/054562

§ 371 Date: Mar. 6, 2018

Related U.S. Application Data
(60) Provisional application No. 62/234,134, filed on Sep. 29, 2015.
(60) Provisional application No. 62/234,137, filed on Sep. 29, 2015.
(60) Provisional application No. 62/234,138, filed on Sep. 29, 2015.

(51) Int. Cl. F21V 7/00; F21V 7/05; F21V 3/04; F21V 15/01

(52) U.S. Cl. CPC F21V 7/0066; F21V 7/05; F21Y 2115/15; F21V 3/049; F21V 15/01; F21V 7/0025

(57) ABSTRACT

Cellular lighting elements and lighting devices including the same are disclosed. A cellular lighting element includes a substrate including a solid state light source, and a light control film. The light control film is made of a single layer of light shaping material. The light control film is formed so as to create a cellular shape, which surrounds, at least in part, the solid state light source. The formed light control film and the substrate form a chamber, which defines an area. The solid state light source is located in the area within the chamber. Plurality of such cellular lighting elements may be joined together form lighting devices.

### CROSS-REFERENCE TO RELATED APPLICATION

The present application is an international application and claims the benefit of, and priority to, U.S. Provisional Patent Application No. 62/234,138, filed Sep. 29, 2015, U.S. Provisional Patent Application No. 62/234,134, filed Sep. 29, 2015, and U.S. Provisional Patent Application No. 62/234,137, filed Sep. 29, 2015, the entire contents of all of which are hereby incorporated by reference.

### TECHNICAL FIELD

The present invention relates to lighting, and more specifically, to formed lighting elements.

### BACKGROUND

Due to its size and structure, light emitted from a solid state light source often looks like it comes from a single point. A group of solid state light sources thus creates the effect of many points of light that might blend together, but are otherwise at least partially seen as distinct. This results in dim spots, dark spots, bright spots, and the like. Due to the typical uniformity of light created by conventional light sources, and the aesthetically pleasing qualities of that uniformity, it is desirable to have uniformity in light emitted by solid state light sources, too. Typically, this results when a batwing distribution is created, either through use of one or more special optics attached to the solid state light sources, or by placing a film having particularly shaped grooves over the solid state light sources.

Conventional light engines typically include such groups of solid state light sources. Such light engines typically use a substrate material, such as FR4 or metal core circuit board, with one or more solid state light sources attached thereto. The substrate can be shaped into a variety of shapes, and can be cut into different sizes as well. Thus, for example, a lamp including one or more solid state light sources typically includes a light engine that fits within the shape of the lamp, while a two foot by two foot troffer style luminaire including one or more solid state light sources typically includes a light engine that is nearly the size of the luminaire. These solid state light source-based light engines, though different in size and composition from conventional light sources, offer increased energy efficiency without the use of mercury or other environmentally unfriendly metals and longer life than conventional light sources. Further, such light engines are typically easy to attach to lighting devices, using, for example, screws.

However, particularly for larger applications, conventional light engines may be costly. Conventional substrate materials add increased weight to a lighting device as well. Thus, light engines made of lightweight, flexible materials have been introduced. Such flexible light engines, including those with printed metal inks on a polymer sheet and those with etched copper traces on laminated polymer sheets, offer cost savings over traditional rigid substrates. Flexible light engines also offer increased design options due to their flexibility.

### SUMMARY

Conventional techniques for creating a batwing distribution add cost and create their own issues, such as increased glare and/or sensitivity to the position of the solid state light source. In some applications and/or devices, adding a lens or a film is not practical, and thus specialized solid state light sources which include optics themselves must be used, potentially significantly increasing cost.

Further, a luminaire or fixture including a light engine is typically is required to have a certain mechanical strength. In order to achieve the required mechanical strength, particularly when a flexible light engine is present, a luminaire typically must also include a metal frame or other stiff structures to hold the flexible light engine in place, so as to maintain the mechanical integrity of the luminaire. This will inevitably increase the cost and weight of the fixture, negating some of the savings realized by using a flexible light engine instead of a conventional light engine. Though the light engine is flexible, the optical system of the luminaire is typically not flexible.

Embodiments provide formed cellular lighting elements that use shaped structures to provide particular light distributions. In some embodiments, these elements are joined together to create a panel of interconnected elements. In some embodiments, these formed elements produce light distributions without the use of optical films. In some embodiments, the films themselves are shaped, which will further alter the behavior of light rays passing through the shaped film(s). The shaped film(s), in some embodiments, are formed and integrated into the lighting device directly. In some embodiments, the films are transparent, and in some embodiments, the films are simple scatters, and in some embodiments, the films are engineered to have more complicated designs. Further, in some embodiments, an indirect orientation of the solid state light sources is used, which in may additionally provide flexible uplighting. Embodiments reduce glare and creating pleasing far-field light distributions. Optical efficiency is increased, as only a small amount of light emitting from one or more solid state light sources is absorbed.

In an embodiment, there is provided a cellular lighting element. The cellular lighting element includes: a substrate including a solid state light source; and a light control film, comprising a single layer of light shaping material, formed to create a cellular shape, wherein the formed light control film surrounds, at least in part, the solid state light source.

In a related embodiment, the formed light control film and the substrate may form a chamber defining an area, wherein the solid state light source may be located in the area within the chamber. In a further related embodiment, light emitted by the solid state light source may exit the chamber by passing through the formed light control film. In another further related embodiment, the chamber may be formed from a portion of the substrate and a portion of the light control film.

In another further related embodiment, the chamber may include a floor, a ceiling, a first wall, a second wall, a third wall, and a fourth wall, the substrate may form the floor and the formed light control film may form the ceiling, the first wall, the second wall, the third wall, and the fourth wall.

In a further related embodiment, the floor and the ceiling may be located in parallel planes. In another further related embodiment, the ceiling may include an indentation. In yet another further related embodiment, the ceiling may include a plurality of indentations. In still another further related embodiment, the ceiling may include a first set of indentations having a first depth and a second set of indentations having a second depth. In a further related embodiment, the first depth may differ from the second depth.

In another related embodiment, the cellular lighting element may further include a formed reflective material having an opening configured to correspond to the cellular shape of the formed light control film, so as to surround, at least in part, the formed light control film.

In another further related embodiment, the chamber may include a floor, a ceiling, a first wall, a second wall, a third wall, and a fourth wall, the substrate may form the ceiling and the formed light control film may form the floor, the first wall, the second wall, the third wall, and the fourth wall.

In still another related embodiment, the formed light control film may include an alignment feature and the substrate may include a corresponding alignment receptacle that mates with the alignment feature. In yet another related embodiment, the formed light control film may include a reflector alignment feature, configured to mate with a corresponding alignment receptacle in a formed reflective material in contact with the formed light control film.

In still another further related embodiment, the formed light control film may be shaped so as to define a cell that surrounds, at least in part, the chamber. In a further related embodiment, the cell may include a first wall, a second wall, a third wall, a fourth wall, and an opening, the chamber may extend in the direction of the opening, and light emitted by the solid state light source may exit the cell through the opening. In a further related embodiment, the formed light control film may include an alignment feature located between the chamber and one of the first wall, the second wall, the third wall, and the fourth wall, and the substrate may include a corresponding alignment receptacle that mates with the alignment feature.

In still yet another related embodiment, the substrate may be at least partially transparent, and light emitted by the solid state light source may exit the cellular lighting element through the at least partially transparent substrate. In a further related embodiment, the formed light control film may include an opening, such that a portion of the light emitted by the solid state light source passes through the opening.

In another embodiment, there is provided a lighting device. The lighting device includes: a substrate including a set of solid state light sources; and a light control film, comprising a single layer of light shaping material, formed to create a plurality of cellular shapes, wherein the formed light control film surrounds, at least in part, a solid state light source in the set of solid state light sources.

In a further related embodiment, the plurality of cellular shapes may be interconnected. In a further related embodiment, a portion of the formed light control sheet interconnecting the plurality of cellular shapes may occupy a plane, and the plurality of cellular shapes may rise out of the plane. In another further related embodiment, a portion of the formed light control sheet interconnecting the plurality of cellular shapes may occupy a plane, and the plurality of cellular shapes may fall below the plane.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a vertical cross section of a plurality of cellular lighting elements according to embodiments disclosed herein.

FIG. 2 shows a vertical cross section of a plurality of cellular lighting elements according to embodiments disclosed herein.

FIG. 3 shows a vertical cross section of a plurality of cellular lighting elements made of a formed light control film according to embodiments disclosed herein.

FIGS. 4-5 show various embodiments of cellular lighting elements made of a formed light control film, according to embodiments disclosed herein.

FIG. 6 shows a close-up view of a portion of a cellular lighting element of FIG. 4.

FIG. 7 shows a plurality of indirect cellular lighting elements, according to embodiments disclosed herein.

FIG. 8 shows a close-up view of a portion of a formed light control film, according to embodiments disclosed herein.

FIGS. 9-11 and 13 show various embodiments of lighting devices including interconnected cellular lighting elements with alignment features, according to embodiments disclosed herein.

FIG. 12 shows a lighting device including a plurality of cellular lighting elements, according to embodiments shown herein.

FIG. 14 shows another embodiment of a plurality of indirect cellular lighting elements, according to embodiments disclosed herein.

### DETAILED DESCRIPTION

Throughout this application, the directional terms “up”, “down”, “upward”, “downward”, “top”, “bottom”, “ceiling”, “floor” and the like are used to describe the absolute and relative orientations of particular elements. For example, some embodiments herein refer to a “top” of a lighting device including a plurality of cellular lighting elements, which one or more solid state light sources sit on, and a “bottom” through which light exits the lighting device. In this example, “top” and “bottom” are used to indicate the typical orientations when the lighting device is installed and operational, typically mounted in a ceiling or as part of a ceiling grid. It is understood that these orientational terms are used only for convenience, and are not intended to be limiting. Thus, when lighting device according to embodiments described herein is, for example, packaged in a box, resting on a counter, leaned up against a wall, or in various stages of assembly on an assembly line, the lighting device may be positioned in any orientation but will still have a “top” that one or more solid state light sources sit on and a “bottom” through which light would exit the lighting device, were it powered and operating. In other words, the orientational terms are used for ease of description and may be used regardless of the actual orientation of the lighting device at a given point in time.

Some embodiments of a lighting device are described throughout as being “floor facing”, for ease and convenience of description, however, embodiments are not so limited. That is, a lighting device according to embodiments is useable in any orientation.

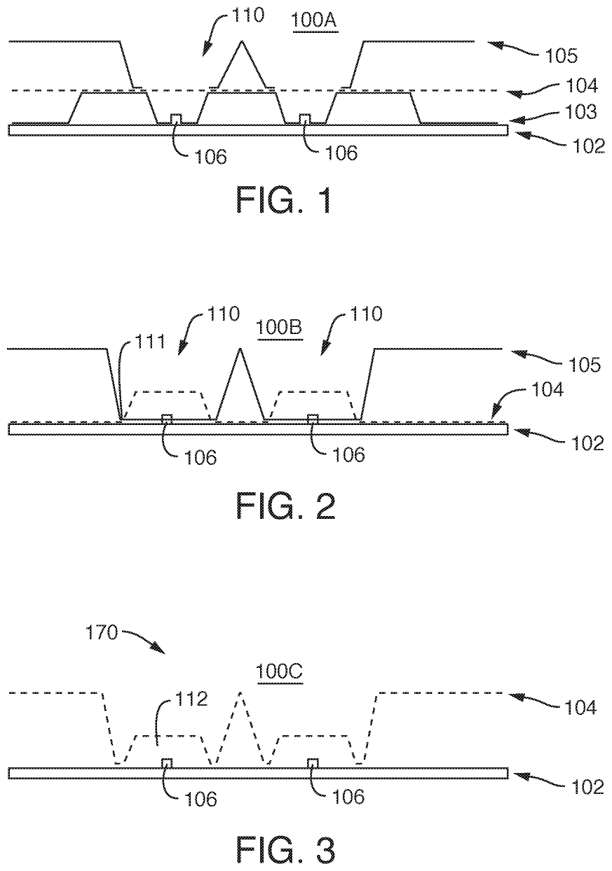

FIG. 1 shows a vertical cross-section of a plurality of cellular lighting elements 100A. The plurality of cellular lighting elements 100A are formed from a lower layer 103, which sits at least in part on a substrate 102, a light control film 104, and an upper layer 105, which in some embodiments is made of a reflective material. The substrate 102 includes one or more solid state light sources 106. In some embodiments, the substrate 102 is a sheet of one or more solid state light sources 106 itself, such as but not limited to an organic light emitting diode (OLED). In the vertical cross-section shown in FIG. 1, the lower layer 103 includes apertures for the one or more solid state light sources 106 and has a certain height, such that the light control film 104 is placed at a certain distance from the light source(s) 106. The light control film 104 then sits on top of the lower layer 103, and the upper layer 105 is above the light control film 104. In some embodiments, such as shown in FIG. 1, the upper layer 105 includes holes that are substantially above the cavity surrounding the solid state light source(s) 106 that is formed by the lower layer 103, as well as walls around these holes to shield the solid state light source(s) 106. This combination results in at least one solid state light source 106 sitting within a cellular lighting element 110.

FIG. 2 shows a vertical cross-section of a plurality of cellular lighting elements 100B that eliminates the lower layer 103 from the plurality of cellular lighting elements 100A of FIG. 1. In FIG. 2, the light control film 104 is shaped such that it rises above and around the one or more solid state light sources 106, but otherwise rests on the substrate 102. In some embodiments, there is an adhesive layer (not shown in FIG. 2) that is interposed between the substrate 102 and the formed light control film 104. The formed reflective material 105 then sits on top of, or is otherwise above, the light control film 104. Note that, in some embodiments, one or more intervening layers and/or materials (not shown in FIG. 2) may be present between the light control film 104 and the formed reflective material 105. The formed reflective material 105 is shaped so as to include walls that rise above the height of the shaped portion of the light control film 104, thus resulting in cellular lighting elements 110. In some embodiments, the formed reflective material 105 includes holes that allow the formed light control film 104 to protrude out of the formed reflective material 105. The formed reflective material 105 includes an opening 111 that corresponds to the cellular shape of the formed light control film 104, so as to surround, at least in part, the formed light control film 104.

FIG. 3 shows a vertical cross-section of a plurality of cellular lighting elements 100C, where the light control film 104 is formed into a particular shape having a variety of structures and is placed on top of the substrate 102. Here, the formed light control film 104 provides the benefits of both the formed light control film 104 of FIG. 2, as described above, and the cellular shape made in part by the formed reflective material 105 that creates desired beam-shaping and other optical effects. Thus, the formed light control film 104 of FIG. 3 balances light transmission and reflection and a minimum of absorption. Light emitted by a solid state light source 106 strikes a bottom surface of the formed light control film 104 (i.e., the surface facing the solid state light source 106). Much of the light is transmitted through the formed light control film 104, but some is reflected, and this is further reflected (i.e., recycled) within the chamber 112, and in some embodiments in part by the substrate 102, which may include a reflective coating and/or be made from reflective material. The transmitted light either exits or is further reflected or transmitted either within a chamber 112 and/or within the cellular lighting element created by the formed light control film 104. The formed light control film 104 shown in FIG. 3 has the same overall shape shown in FIG. 2, which is the combination of the shape of the formed reflective material 105 shown in FIG. 2 and the formed light control film 104 shown in FIG. 2.

The formed light control film 104 is made of a single layer of light shaping material, though in some embodiments, multiple layers may be and are combined together. The formed light control film 104 is formed so as to create a cellular shape 170, within which is found a solid state light source 106. Thus, the formed light control film 104 surrounds, at least in part, the solid state light source 106.

The formed light control film 104 and the substrate 102 form a chamber 112. The chamber 112 defines an area, and the solid state light source 106 is located in the area within the chamber 112. Thus, in some embodiments, a chamber 112 is formed from a portion of the substrate 102 and a portion of the light control film 104.

The formed light control film 104 is shaped so as to define a cell 170, or cellular shape 180, that surrounds, at least in part, the chamber 112.

In some embodiments, the cell 170 and/or cellular shape 180 includes a first wall 140, a second wall 141, a third wall 142, a fourth wall 143, and an opening 144, wherein the chamber 112 extends in the direction of the opening 144, and wherein light emitted by the solid state light source 106 exits the cell 170 through the opening 144.

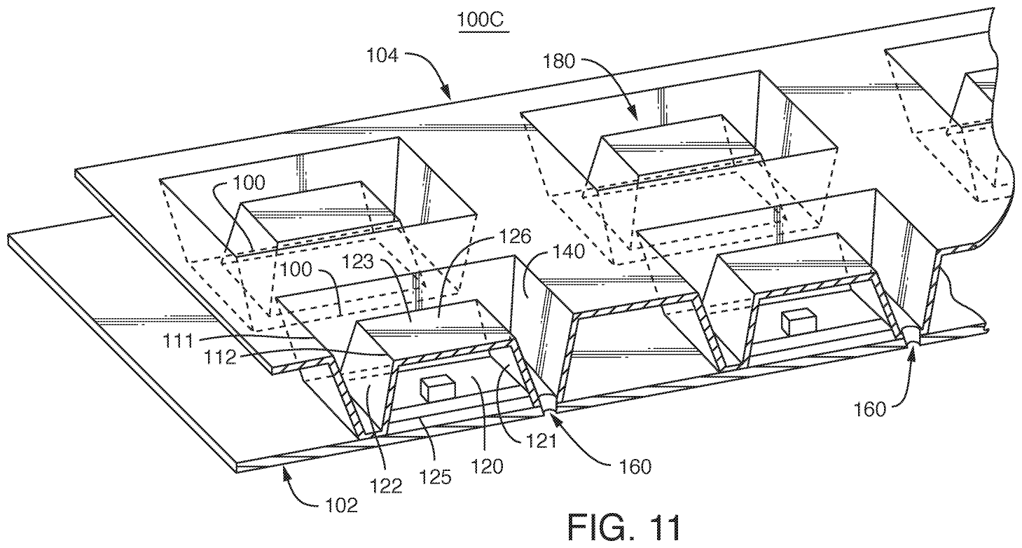

As seen most clearly in FIG. 11, in some embodiments, the chamber 112 includes a floor 125, a ceiling 126, a first wall 120, a second wall 121, a third wall 122, and a fourth wall 123. In some embodiments, as shown in FIG. 11, the substrate 102 forms the floor 125 and the formed light control film 104 forms the ceiling 126, the first wall 120, the second wall 121, the third wall 122, and the fourth wall 123. In some embodiments, this arrangement is switched. In some embodiments, as shown in FIG. 3 but also FIG. 11, the floor 125 and the ceiling 126 are located in parallel planes.

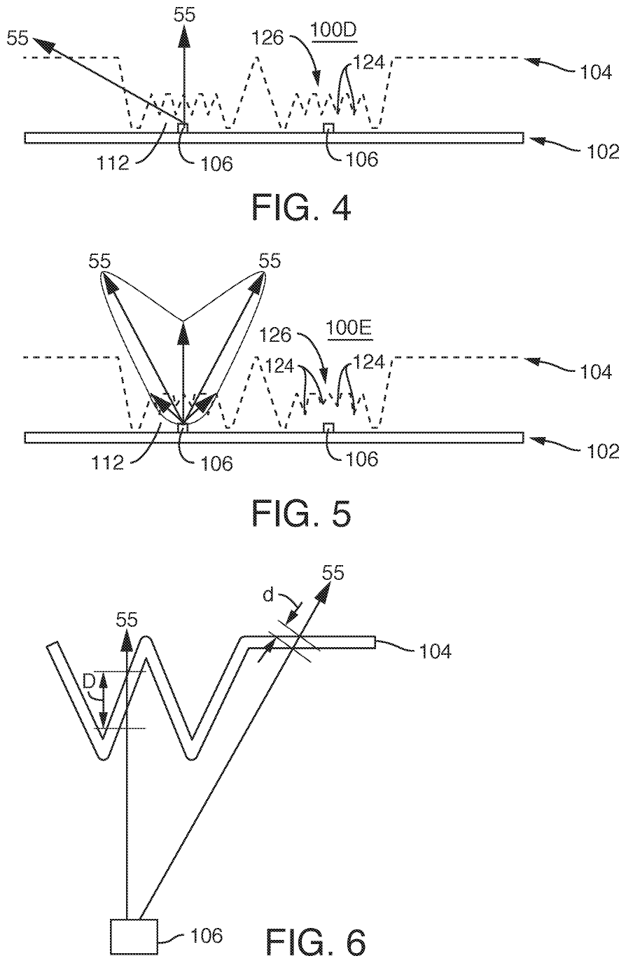

FIGS. 4 and 5 show vertical cross-sections of pluralities of cellular lighting elements 100D, 100E, where the ceiling 126 of the chamber 112 includes an indentation 124. In some embodiments, there is a plurality of indentations 124 in the ceiling 126 of the chamber 112. The indentation(s) 124, in some embodiments, are similarly shaped, or shaped the same, and in some embodiments, are shaped differently. For example, as shown in FIG. 5, the ceiling 126 includes a first set 124a of indentations having a first depth, and a second set 124B of indentations having a second depth, where the first depth differs from the second depth.

As shown most clearly in FIGS. 4 and 5, light (indicated by rays 55) emitted by the solid state light source(s) 106 exit the chamber 112 by passing through the formed light control film 104.

Though the shapes shown in FIGS. 3-5 have particular characteristics, of course, embodiments are not so limited and thus include other shapes and structures having other sizes than those shown. Embodiments advantageously provide for beam shaping and other optical controls with a simple forming process applied to the light control film 104. No other parts are need to achieve these additional optical controls.

In some embodiments, the indentations in FIGS. 4 and 5 are varied in terms of shape, size, and location, resulting in a batwing distribution. As shown in FIG. 6, the light at zero degrees above the solid state light source 106 is incident on the formed light control film 104 at a larger angle, and thus experiences a larger thickness of the formed light control film 104. As a result, the chance is greater for light to be redirected (e.g., scattered) close to zero degrees compared to that at thirty degrees, which explains the resultant batwing distribution. A Fresnel reflection occurs at the surface of the formed light control film 104, which results in light at zero degrees being incident onto the formed light control film 104 at a much larger angle.

In embodiments shown in FIGS. 4-5, it is possible to mold even smaller features into the formed light control film 104. Such features may include, but are not limited to, various patterns including various geometric shapes, though of course embodiments are not so limited and combinations of any such patterns are possible. The chosen pattern, in some embodiments, depends on the desired light output. In some embodiments, the thickness of the formed light control film is varied so as to further impact beam shaping. For example, in some embodiments, the formed light control film is of a thinner thickness, resulting in a more transparent formed light control film than a formed light control film having a thicker thickness.

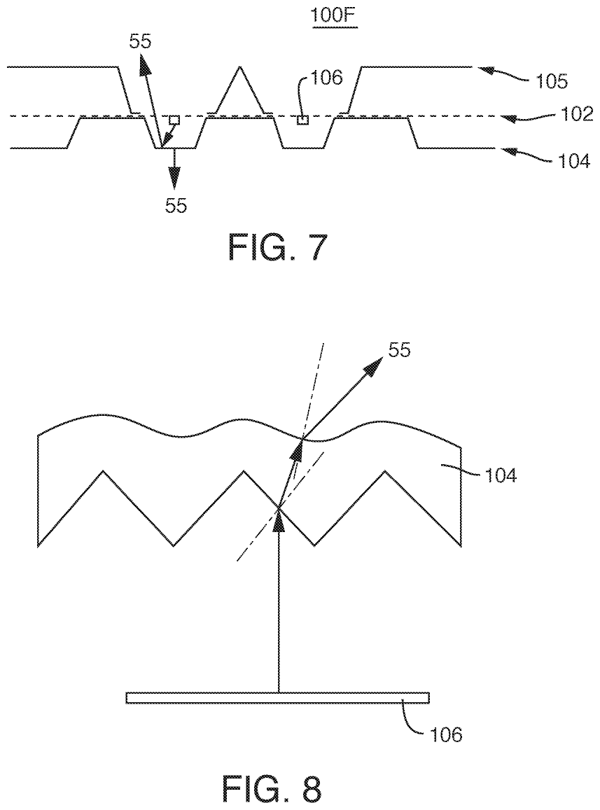

FIG. 7 shows a vertical cross-sectional view of a plurality of indirect cellular lighting elements 100F. Here, the substrate 102 is at least partially light transmissive, or transparent, while the formed light control film 104 is partially diffusive and partially reflective. Thus, some light (shown by rays 55) emitted from the solid state light source 106 will strike the formed light control film 104 and be reflected back, through the substrate 102, while some light passes through the formed light control film 104. Such embodiments provide for additional source hiding and in some embodiments a greater batwing distribution, particularly if the formed light control film 104 has some specularly reflective properties.

FIG. 8 shows a formed light control film 104 including features that were intrinsic to, or artifacts of, the forming process. During a typical forming process, a plastic sheet, such as but not limited to PET, is heated up and softened. Once it reaches the desired temperature, the sheet is pulled to a bottom mold by vacuum (the bottom mold includes small holes to allow the vacuum to come in). The formed sheet of light control film 104 is then cooled and released from the mold. Only one side of the sheet is in contact with the mold. Thus, it is difficult to maintain the shape for the other side of the sheet, which has no direct contact with the mold, especially for smaller V-shaped grooves and/or thicker sheets. As a result, for example, a much milder wave-like structure results on the other side of the sheet, as shown in FIG. 8. This milder wave-like structure, which is intrinsic to the forming process, results in a light control film 104 that is able to achieve, for example, batwing light distributions.

Though the cross-sections shown in FIGS. 1-5 represent structures that are capable of producing desired light output distributions, from a manufacturing perspective, these structures require time and effort to create. In some embodiments, two primary issues exist: proper alignment and how to hold things together. Regarding alignment, some embodiments employ co-registered sheets for the layers that are aligned using interlock features. For example, simple tapered “pins” are formed in the substrate and fit through one or more corresponding mating holes on the formed light control film. In some embodiments, the alignment features can pass through apertures punched or otherwise created in the film(s). Regarding fastening, some embodiments use adhesives, dispensed in mating locations throughout. Some embodiments alternatively, or additionally, use a barb/mushroom feature formed in the substrate that retains the formed light control film and/or formed reflective material when pressed together. Some embodiments use heatstacking, ultrasonic welding, or plastic rivets or other fasteners.

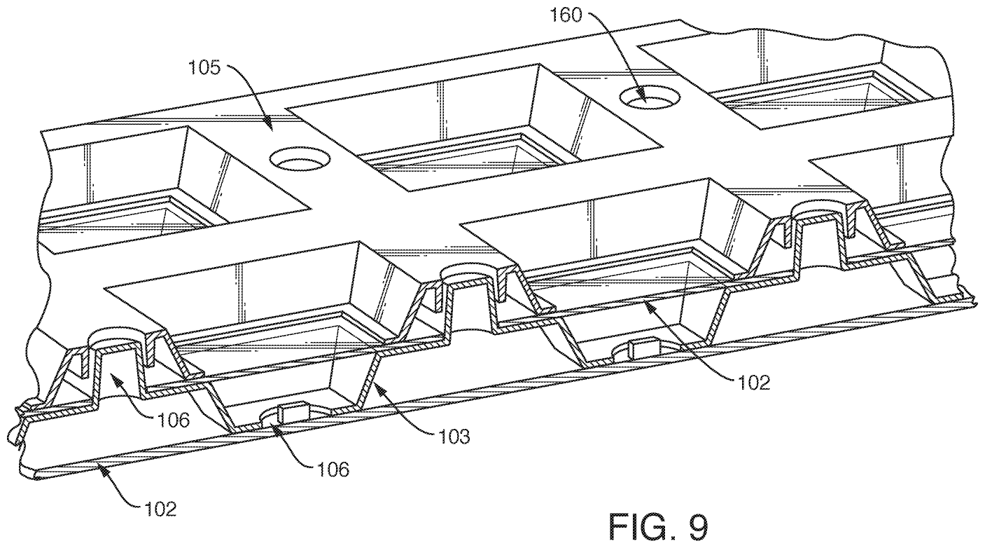

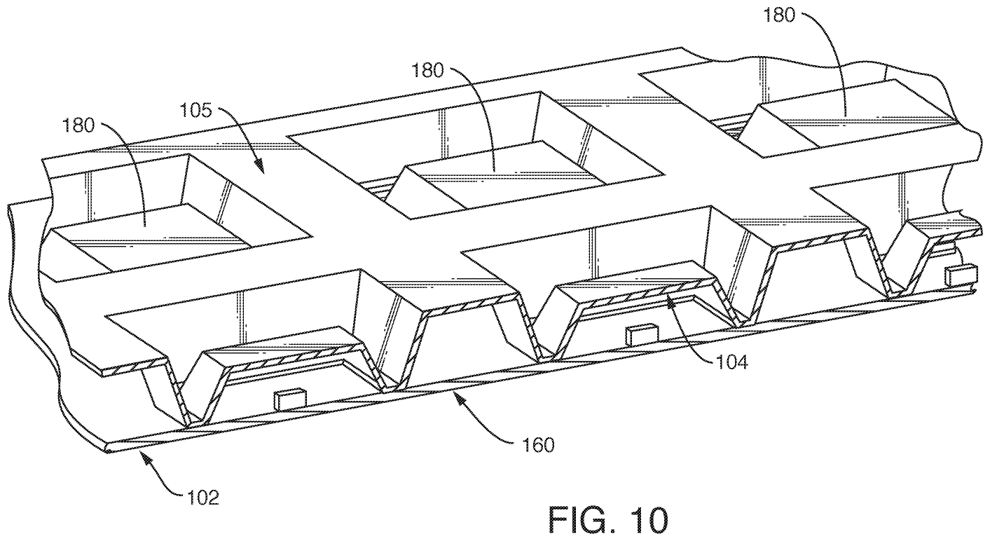

FIGS. 9-11 show partial perspective views of embodiments of lighting devices including plurality of cellular lighting elements that include alignment features 160, such as those described above, enabling faster, easier manufacturing. FIG. 10 shows a perspective view of FIG. 2 that includes a set of alignment features 160 in the substrate 102. Alternatively, or additionally, the formed reflective material 105 is aligned directly to the substrate 102 via its own set of extruded pins (not shown). FIG. 11 shows a set of formed alignment “pin” features 160. In FIG. 11, the formed light control film 104 includes an alignment feature 160 and the substrate 102 includes a corresponding alignment receptacle 160 that mates with the alignment feature 160. In some embodiments, such as shown in FIG. 11, the formed light control film 104 includes an alignment feature 160 located between the chamber 112 and one of the a wall 140, a second wall 141, a third wall 142, and a fourth wall 143, all of the cellular element 180. The substrate 102 in such embodiments includes a corresponding alignment receptacle 160 that mates with the alignment feature 160.

FIG. 13 shows a plurality of cellular lighting elements 170, each made from formed light control film 104, having an alignment feature 160 that protrudes up from an uppermost portion of the cellular lighting element 170. This allows for alignment with, for example, a formed reflective material 105 such as shown in FIG. 2.

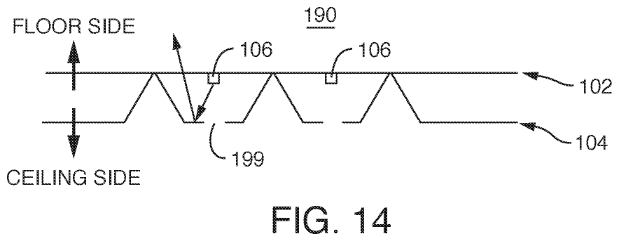

FIG. 14 shows a cross-section of a plurality of indirect cellular lighting elements 190. The solid state light sources 106 face the ceiling side, and the substrate 102 is either transparent, partially transmissive and partially reflective, or partially filled the aperture (e.g., a narrow substrate with white solder mask or reflective sheet such as white PET). In such embodiments, light emitted from the solid state light sources 106 goes up towards the ceiling side, and is reflected back to the floor side by the cellular lighting elements made from the formed light control film 104. In some embodiments, as shown in FIG. 14, one or more holes 199 or other similar features allow some of the light emitted to be emitted up towards the ceiling side, creating an uplight effect. The uplight effect, in some embodiments, is modified to produce a certain light distribution and/or pattern of light, such as but not limited to a logo. In some embodiments, instead of each cellular lighting element including a single hole or opening, each element includes a plurality of smaller holes, which in some embodiments leads to a certain uplit image. Though the cellular lighting elements shown in the vertical cross-sectional view of FIG. 14 are trapezoidal in cross-section, of course embodiments are not so limited, and the elements in some embodiments take any of the shapes described in co-pending PCT Application Nos. PCT/US15/33605 and PCT/US15/33606, the entire contents of both of which are hereby incorporated by reference.

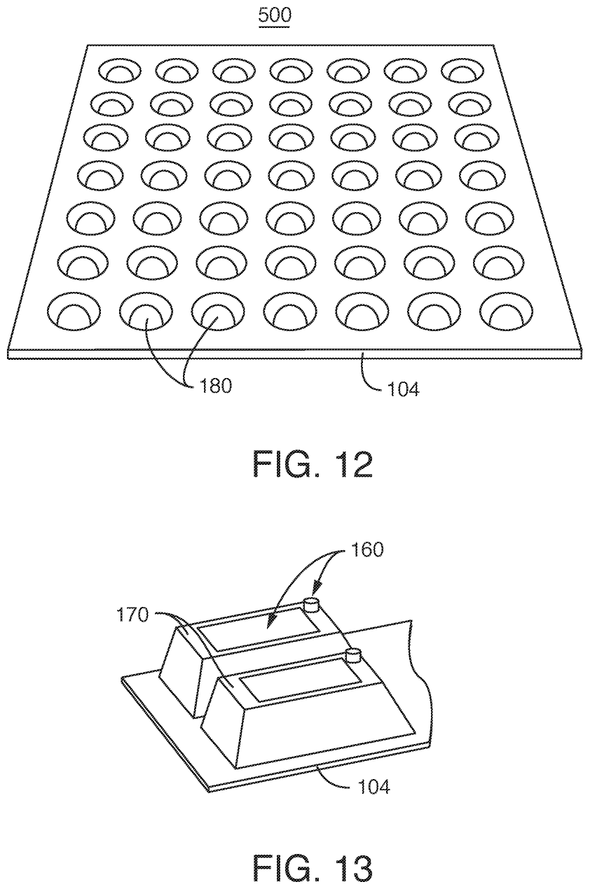

FIG. 12 shows a lighting device 500 including a substrate having a set of solid state light sources (not visible in FIG. 12 but seen in FIGS. 9-11) and a light control film 104. The light control film 104 is made of a single layer of light shaping material, and is formed to create a plurality of cellular shapes 180, such that the formed light control film 104 surrounds, at least in part, a solid state light source in the set of solid state light sources, which are emitting the light shown leaving the cellular shapes 180. As seen, the plurality of cellular shapes are interconnected. In some embodiments, such as shown in FIG. 10, a portion of the formed light control sheet 104 interconnecting the plurality of cellular shapes 180 occupies a plane, and the plurality of cellular shapes 180 rise out of the plane. In some embodiments, as shown in FIG. 12, the plurality of cellular shapes 180 fall below the plane.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A cellular lighting element, comprising:
a substrate including a solid state light source; and
a light control film, comprising a single layer of light shaping material, formed to create a cellular shape, wherein the formed light control film surrounds, at least in part, the solid state light source.

2. The cellular lighting element of claim 1, wherein the formed light control film and the substrate form a chamber defining an area, wherein the solid state light source is located in the area within the chamber.

3. The cellular lighting element of claim 2, wherein light emitted by the solid state light source exits the chamber by passing through the formed light control film.

4. The cellular lighting element of claim 2, wherein the chamber is formed from a portion of the substrate and a portion of the light control film.

5. The cellular lighting element of claim 2, wherein the chamber includes a floor, a ceiling, a first wall, a second wall, a third wall, and a fourth wall, wherein the substrate forms the floor and wherein the formed light control film forms the ceiling, the first wall, the second wall, the third wall, and the fourth wall.

6. The cellular lighting element of claim 5, wherein the floor and the ceiling are located in parallel planes.

7. The cellular lighting element of claim 5, wherein the ceiling includes an indentation.

8. The cellular lighting element of claim 5, wherein the ceiling includes a plurality of indentations.

9. The cellular lighting element of claim 5, wherein the ceiling includes a first set of indentations having a first depth and a second set of indentations having a second depth.

10. The cellular lighting element of claim 9, wherein the first depth differs from the second depth.

11. The cellular lighting element of claim 1, further comprising:
a formed reflective material having an opening configured to correspond to the cellular shape of the formed light control film, so as to surround, at least in part, the formed light control film.

12. The cellular lighting element of claim 2, wherein the chamber includes a floor, a ceiling, a first wall, a second wall, a third wall, and a fourth wall, wherein the substrate forms the ceiling and wherein the formed light control film forms the floor, the first wall, the second wall, the third wall, and the fourth wall.

13. The cellular lighting element of claim 1, wherein the formed light control film includes an alignment feature and the substrate includes a corresponding alignment receptacle that mates with the alignment feature.

14. The cellular lighting element of claim 1, wherein the formed light control film includes a reflector alignment feature, configured to mate with a corresponding alignment receptacle in a formed reflective material in contact with the formed light control film.

15. The cellular lighting element of claim 2, wherein the formed light control film is shaped so as to define a cell that surrounds, at least in part, the chamber.

16. The cellular lighting element of claim 15, wherein the cell includes a first wall, a second wall, a third wall, a fourth wall, and an opening, wherein the chamber extends in the direction of the opening, and wherein light emitted by the solid state light source exits the cell through the opening.

17. The cellular lighting element of claim 16, wherein the formed light control film includes an alignment feature located between the chamber and one of the first wall, the second wall, the third wall, and the fourth wall, and the substrate includes a corresponding alignment receptacle that mates with the alignment feature.

18. The cellular lighting element of claim 1, wherein the substrate is at least partially transparent, and light emitted by the solid state light source exits the cellular lighting element through the at least partially transparent substrate.

19. The cellular lighting element of claim 18, wherein the formed light control film includes an opening, such that a portion of the light emitted by the solid state light source passes through the opening.

20. A lighting device, comprising:
a substrate including a set of solid state light sources; and
a light control film, comprising a single layer of light shaping material, formed to create a plurality of cellular shapes, wherein the formed light control film surrounds, at least in part, a solid state light source in the set of solid state light sources.

21. The lighting device of claim 20, wherein the plurality of cellular shapes are interconnected.

22. The lighting device of claim 21, wherein a portion of the formed light control sheet interconnecting the plurality of cellular shapes occupies a plane, and wherein the plurality of cellular shapes rise out of the plane.

23. The lighting device of claim 21, wherein a portion of the formed light control sheet interconnecting the plurality of cellular shapes occupies a plane, and wherein the plurality of cellular shapes fall below the plane.
